(19) United States
(12) Patent Application Publication
(10) Pub. No.: US 2025/0135793 A1
(43) Pub. Date: May 1, 2025

(54) MOVING DEVICE, MOVING SYSTEM, AND MOVING METHOD

(71) Applicant: SEIKO EPSON CORPORATION, Tokyo (JP)

(72) Inventor: Nobuhiro INOUE, MATSUMOTO-SHI (JP)

(21) Appl. No.: 18/926,537

(22) Filed: Oct. 25, 2024

(30) Foreign Application Priority Data
Oct. 27, 2023 (JP) 2023-184461

(51) Int. Cl. B41J 25/308; B41J 2/32; B41J 15/04; B41J 25/00; B41J 25/316; B41J 29/13; B41J 29/387; B41J 29/48

(52) U.S. Cl. CPC B41J 25/308; B41J 2/32; B41J 15/04; B41J 25/001; B41J 25/316; B41J 29/13; B41J 29/387; B41J 29/48

(57) ABSTRACT

A moving device includes a moving mechanism configured to support a plurality of printers and move positions of the plurality of printers, the plurality of printers being configured to execute printing processing for executing printing on roll paper, a take-out port through which a user takes out a receipt discharged from a first printer being one printer of the plurality of printers, and a first control unit configured to communicate with the plurality of printers and control the moving mechanism, wherein the first control unit includes a monitoring unit configured to monitor a state of each of the plurality of printers, and a movement instruction unit configured to cause the moving mechanism to move a position of the first printer to a take-out position at which the receipt is taken out through the take-out port, based on a monitoring result of the monitoring unit.

The present application is based on, and claims priority from JP Application Serial Number 2023-184461, filed Oct. 27, 2023, the disclosure of which is hereby incorporated by reference herein in its entirety.

### BACKGROUND

### 1. Technical Field

The present disclosure relates to a moving device, a moving system, and a moving method.

### 2. Related Art

Hitherto, there has been known a printing device capable of accommodating roll paper.

For example, JP-A-2023-121273 describes a printing device that can save recording paper while suppressing a paper jam.

In a printing device such as a printer that executes printing on roll paper, which is similar to the printing device described in JP-A-2023-121273, when printing is interrupted due to some factors, it is desired to shorten the time during which the printing is interrupted.

### SUMMARY

In order to solve the above-mentioned problem, an aspect is a moving device including a moving mechanism configured to support a plurality of printing devices and move positions of the plurality of printing devices, the plurality of printing devices being configured to execute printing processing for executing printing on roll paper, a take-out port through which a user takes out a printed material discharged from a first printing device being one of the plurality of printing devices, and a control unit configured to communicate with the plurality of printing devices and control the moving mechanism, wherein the control unit includes a monitoring unit configured to monitor a state of each of the plurality of printing devices, and a movement instruction unit configured to cause the moving mechanism to move a position of the first printing device to a take-out position at which the printed material is taken out through the take-out port, based on a monitoring result of the monitoring unit.

In order to solve the above-mentioned problem, another aspect is a moving system including a moving device configured to support a plurality of printing devices and move positions of the plurality of printing devices, the plurality of printing devices being configured to execute printing processing for executing printing on roll paper, a take-out port through which a user takes out a printed material discharged from a first printing device being one printing device of the plurality of printing devices, and a control device configured to communicate with the plurality of printing devices and control the moving device, wherein the control device includes a monitoring unit configured to monitor a state of each of the plurality of printing devices, and a movement instruction unit configured to cause the moving device to move a position of the first printing device to a take-out position at which the printed material is taken out through the take-out port, based on a monitoring result of the monitoring unit.

In order to solve the above-mentioned problem, another aspect is a moving method in a moving device including a moving mechanism configured to support a plurality of printing devices and move positions of the plurality of printing devices, the plurality of printing devices being configured to execute printing processing for executing printing on roll paper, a take-out port through which a user takes out a printed material discharged from a first printing device being one printing device of the plurality of printing devices, and a control unit configured to communicate with the plurality of printing devices and control the moving mechanism, the moving method including a monitoring step by the control unit for monitoring a state of each of the plurality of printing devices, and a movement instruction step by the control unit for causing the moving mechanism to move a position of the first printing device to a take-out position at which the printed material is taken out through the take-out port, based on a monitoring result in the monitoring step.

In order to solve the above-mentioned problem, a further another aspect is a movement control program in a moving device including a moving mechanism configured to support a plurality of printing devices and move positions of the plurality of printing devices, the plurality of printing devices being configured to execute printing processing for executing printing on roll paper, a take-out port through which a user takes out a printed material discharged from a first printing device being one printing device of the plurality of printing devices, and a control unit configured to communicate with the plurality of printing devices and control the moving mechanism, the movement control program causing a processor provided to the control unit to function as a monitoring unit configured to monitor a state of each of the plurality of printing devices and a movement instruction unit configured to cause the moving mechanism to move a position of the first printing device to a take-out position at which the printed material is taken out through the take-out port, based on a monitoring result of the monitoring unit.

### BRIEF DESCRIPTION OF THE DRAWINGS

FIG. 1 is a perspective view illustrating an example of an outer appearance of a printer according to the present embodiment.

FIG. 2 is a side view illustrating an example of the configuration of the printer.

FIG. 3 is a view illustrating an example of a configuration of a moving mechanism according to a first embodiment.

FIG. 4 is a view illustrating an example of a configuration of a moving mechanism according to a second embodiment.

FIG. 5 is a view illustrating an example of a configuration of a moving system according to the present embodiment.

FIG. 6 is a flowchart illustrating an example of processing of a first control unit.

FIG. 7 is a flowchart illustrating an example of maintenance processing of the first control unit.

### DESCRIPTION OF EMBODIMENTS

An embodiment is described below with reference to the accompanying drawings.

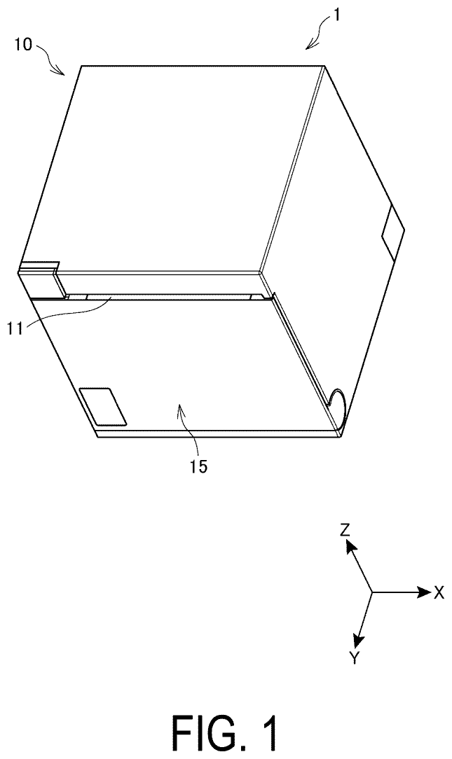

In FIG. 1 to FIG. 4, an X-axis, a Y-axis, and a Z-axis are illustrated. The X-axis, the Y-axis, and the Z-axis are orthogonal to one another. The Z-axis indicates an up-and-down direction in an installation state of a printer 1 and a vertical direction. Each of the X-axis and the Y-axis is parallel to a horizontal direction. The Y-axis indicates a front-and-rear direction of the printer 1. The X-axis indicates a right-and-left direction of the printer 1. A positive direction of the Z-axis indicates an upward direction. A positive direction of the Y-axis indicates a frontward direction. A positive direction of the X-axis indicates a rightward direction. Note that the side surface of the printer 1 on the front side is regarded as the front surface of the printer 1.

FIG. 1 is a perspective view illustrating an example of an outer appearance of the printer 1 according to the present embodiment. The printer 1 of the present embodiment includes a printing function.

The printer 1 corresponds to an example of a “printing device”.

In the present embodiment, description is made on a case in which the “printing device” is the printer 1. However, the embodiment is not limited thereto. The “printing device” is only required to include a printing function. For example, the “printing device” may be a copier. Further, for example, the “printing device” may be multi-function peripherals (MFP). The MFP is a multi-function device that includes various functions such as a printing function, a copying function, a facsimile function, and a scanning function.

As illustrated in FIG. 1, the printer 1 includes a housing 10. The housing 10 accommodates each of units of the printer 1.

The housing 10 is formed into a substantially cube-like shape. The housing 10 includes a discharge port 11 and a door 15.

Through the discharge port 11, a receipt is discharged to the outside. The discharge port 11 is formed in the upper part of the front surface of the housing 10. The discharge port 11 is formed into a slit-like shape extending in the right-and-left direction.

The door 15 is configured to be opened and closed freely, and is in an opened state when the printer 1 is subjected to maintenance, for example. The door 15 is arranged at the front surface of the housing 10.

The receipt corresponds to an example of a “printed material”.

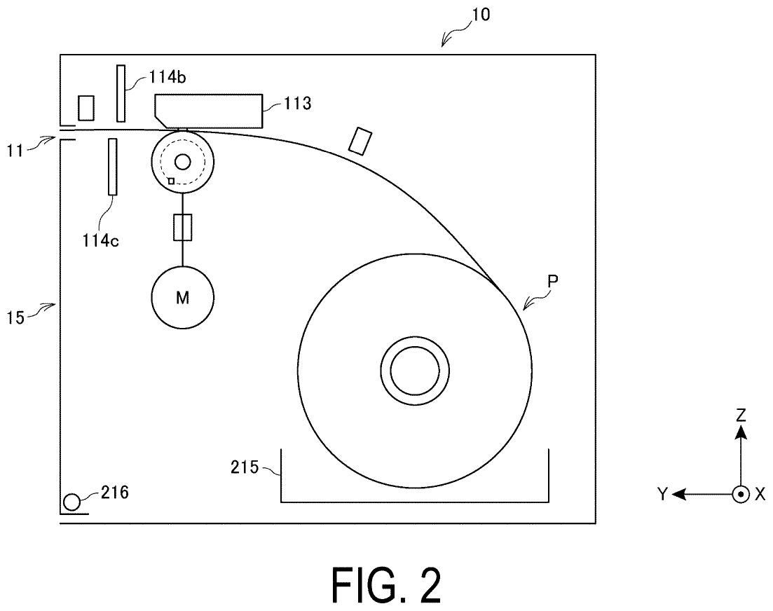

FIG. 2 is a side view illustrating an example of the configuration of the printer 1. In FIG. 2, the right side surface of the housing 10 is omitted in illustration for the sake of convenience.

As illustrated in FIG. 2, the printer 1 includes an accommodation tray 215, a printing head 113, a movable blade 114c, a fixed blade 114b, and a support shaft 216. The accommodation tray 215, the printing head 113, the movable blade 114c, the fixed blade 114b, and the support shaft 216 are accommodated inside the housing 10.

The accommodation tray 215 accommodates the roll paper P. For example, the roll paper P is heat-sensitive paper. The accommodation tray 215 is arranged at the lower part of the housing 10.

For example, the printing head 113 is a thermal head. The printing head 113 includes a plurality of heat generating elements. The plurality of heat generating elements are electrically energized to generate heat. When the printing head 113 applies the heat to the heat-sensitive paper, an image is formed on the heat-sensitive paper.

The movable blade 114c and the fixed blade 114b cut the heat-sensitive paper on which printing is executed. The movable blade 114c is configured to move in the up-and-down direction of FIG. 2. The movable blade 114c moves upward, and the heat-sensitive paper is sandwiched between the fixed blade 114b and the movable blade 114c. Then, the heat-sensitive paper is cut. Then, the receipt being generated is discharged through the discharge port 11.

Further, the door 15, which is described with reference to FIG. 1, is supported by the support shaft 216 illustrated in FIG. 2. The support shaft 216 extends in the right-and-left direction. The door 15 is supported while the lower end of the door 15 is supported in a freely turnable manner by the support shaft 216. The door 15 turns frontward to be in an opened state. When the door 15 is in an opened state, a user can execute maintenance such as replacement of the roll paper P and the like.

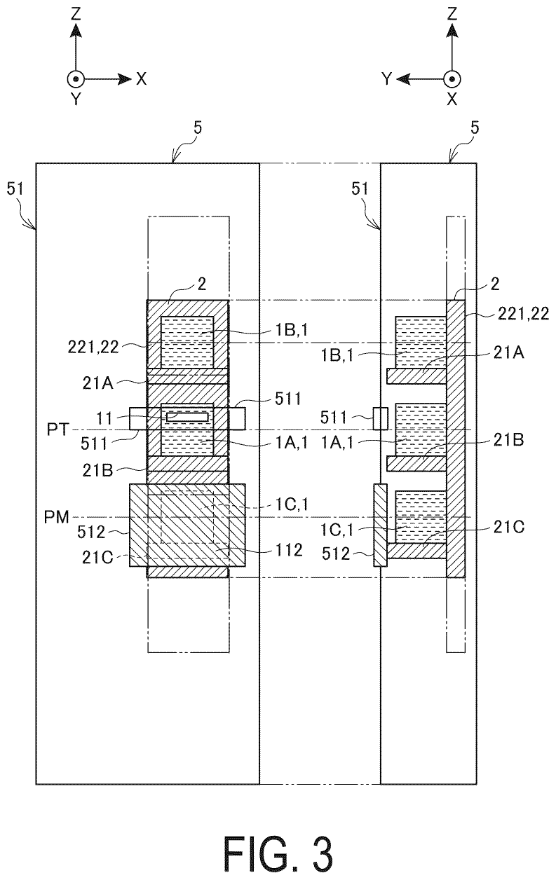

Next, with reference to FIG. 3, a configuration of the moving mechanism 2 according to the first embodiment is described. FIG. 3 is a view illustrating an example of the configuration of the moving mechanism 2 according to the first embodiment. The left part of FIG. 3 is a front view, and the right part of FIG. 3 is a side view.

As illustrated in FIG. 3, for example, the moving mechanism 2 is accommodated inside a housing 51 of a so-called self-checkout machine 5. The self-checkout machine 5 is a checkout machine (cash register machine) with which a customer executes a settlement operation. For example, the self-checkout machine 5 is installed at a supermarket or the like.

The housing 51 includes a take-out port 511 and a maintenance door 512.

The take-out port 511 is a receipt reception tray configured so that a user can take out a receipt discharged from a first printer 1A. A take-out position PT is set so that the discharge port 11 through which the receipt from the first printer 1A is discharged overlaps with at least a part of the take-out port 511 in front view of the take-out port 511. For example, the take-out position PT is a position of the first printer 1A at which the receipt from the first printer 1A can be taken out through the take-out port 511. Note that, in the moving mechanism 2 according to the first embodiment, the position of the first printer 1A is a position of the first printer 1A in the up-and-down direction.

The first printer 1A corresponds to an example of a “first printing device”.

The maintenance door 512 is arranged at a position facing a maintenance position PM, and allows a user to execute maintenance work for a third printer 1C. The maintenance position PM is a position at which the maintenance work is executed. The third printer 1C is the printer 1 being a target subjected to the maintenance work by a user.

As illustrated in FIG. 3, in the first embodiment, the maintenance door 512 is arranged at the front surface of the housing 51. Further, for example, the maintenance door 512 turns frontward with the support shaft, which is arranged at the lower end of the maintenance door 512, as a center to be in an opened state. The maintenance door 512 is configured so that the roll paper P of the third printer 1C can be replaced while the maintenance door 512 is in an opened state.

The third printer 1C corresponds to an example of a “third printing device”.

The moving mechanism 2 moves positions of plurality of printers 1. The moving mechanism 2 moves the plurality of printers 1 in the vertical direction with respect to the take-out port 511. In the moving mechanism 2 according to the first embodiment, the plurality of printers 1 includes the first printer 1A, a second printer 1B, and the third printer 1C.

The moving mechanism 2 includes a first support member 21A, a second support member 21B, a third support member 21C, and a lift mechanism 22. The lift mechanism 22 includes a lift member 221.

The lift member 221 extends in the up-and-down direction. For example, the lift member 221 is configured by a rectangular plate-like member. The lift member 221 is configured to freely move upward and downward along a guide member of the lift mechanism 22, which is omitted in illustration. For example, the lift member 221 is driven to move upward and downward by a motor of the lift mechanism 22, which is omitted in illustration. The motor drives the lift member 221 to move upward and downward, according to an instruction from a control device 3.

Further, a sensor, which is omitted in illustration, is arranged at the lift mechanism 22. The sensor detects a position of the lift member 221 in the up-and-down direction. Based on the detection result of the sensor, the control device 3 drives the motor.

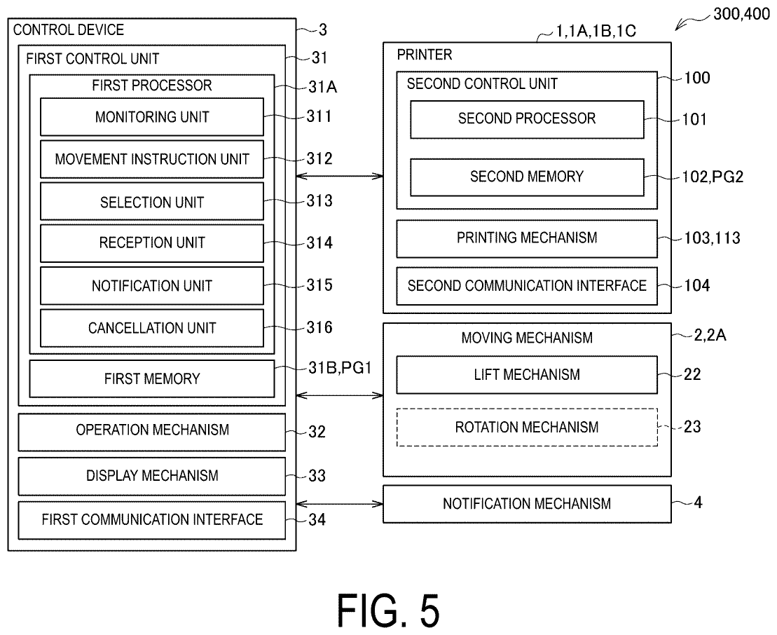

The configuration of the control device 3 is further described with reference to FIG. 5.

For example, the first support member 21A, the second support member 21B, and the third support member 21C are each configured by a rectangular plate-like member. The first support member 21A, the second support member 21B, and the third support member 21C are each formed to have substantially the same shape and substantially the same size. The first support member 21A, the second support member 21B, and the third support member 21C are sequentially arrayed from the top to the bottom along the vertical direction. The interval between the first support member 21A and the second support member 21B is the same as the interval between the second support member 21B and the third support member 21C. The interval between the first support member 21A and the second support member 21B and the interval between the second support member 21B and the third support member 21C are decided according to the height of the printer 1.

Further, for example, the rear side of each of the first support member 21A, the second support member 21B, and the third support member 21C is fixed to the lift member 221. In other words, the first support member 21A, the second support member 21B, and the third support member 21C are driven to move upward and downward by the motor, which is omitted in illustration, while being integrated with the lift member 221.

The first support member 21A, the second support member 21B, and the third support member 21C are configured to be substantially the same. Thus, when there is no need to distinguish those members, they may be referred to as a support member 21.

As illustrated in FIG. 3, the moving mechanism 2 according to in the first embodiment, the first printer 1A is placed on the upper surface of the second support member 21B. Further, the second printer 1B is placed on the upper surface of the first support member 21A. Further, the third printer 1C is placed on the upper surface of the third support member 21C. Note that in the first embodiment, a case in which the printer 1 is placed on the upper surface of the support member 21 is described. However, the embodiment is not limited thereto. The printer 1 may be fixed to the upper surface of the support member 21 by a bolt or the like. In this case, for example, even when an acceleration degree caused by driving the lift member 221 by the lift mechanism 22 is relatively high, the position of the printer 1 with respect to the support member 21 can be prevented from moving.

In the moving mechanism 2 according to the first embodiment illustrated in FIG. 3, the first printer 1A is arranged at the take-out position PT. The take-out position PT is a position of the printer 1 at which the receipt discharged from the printer 1 can be taken out through the take-out port 511. For example, the position of the printer 1 is the center position of the printer 1 in the up-and-down direction.

For example, the take-out position PT is set so that the discharge port 11 through which the receipt from the first printer is discharged overlaps with the take-out port 511 in front view of the take-out port 511. For example, the take-out position PT is set so that the discharge port 11 is included in the take-out port 511 in front view of the take-out port 511. In this case, the receipt discharged through the discharge port 11 can securely be placed on the take-out port 511.

In the moving mechanism 2 according to the first embodiment illustrated in FIG. 3, the third printer 1C is arranged at the maintenance position PM. The maintenance position PM is the position of the printer 1 when the maintenance work on the printer 1 is executed. In other words, the maintenance position PM is a position facing the maintenance door 512. For example, the position of the printer 1 is the center position of the printer 1 in the up-and-down direction. For example, the maintenance work includes work for replacing the roll paper P. When the maintenance door 512 is in an opened state, the maintenance work can easily be executed.

In the first embodiment, a case in which the moving mechanism 2 includes the lift mechanism 22 is described. However, the embodiment is not limited thereto. For example, in place of the lift mechanism 22, the moving mechanism 2 may include a slide mechanism. The slide mechanism moves the plurality of printers 1 in the horizontal direction with respect to the take-out port 511. For example, the plurality of printers 1 includes the first printer 1A, the second printer 1B, and the third printer 1C.

For example, in place of the lift member 221, the slide mechanism includes a slide member. For example, the slide member extends in the right-and-left direction or the front-and-rear direction. For example, the slide member is configured to freely slide in the right-and-left direction or the front-and-rear direction by a motor, which is omitted in illustration. In the slide member, for example, the first support member, the second support member, and the third support member 21C are arranged at an equal interval in the right-and-left direction or the front-and-rear direction. The first printer 1A is placed on the upper surface of the second support member. Further, the second printer 1B is placed on the upper surface of the first support member. Further, the third printer 1C is placed on the upper surface of the third support member. In this case, the first support member, the second support member, and the third support member may be configured to be integrated with each other.

For example, when the moving mechanism 2 includes the slide mechanism that moves the plurality of printers 1 in the right-and-left direction, the size of the moving mechanism 2 in the up-and-down direction and the front-and-rear direction can be reduced.

Further, for example, when the moving mechanism 2 includes the slide mechanism that moves the plurality of printers 1 in the front-and-rear direction, the size of the moving mechanism 2 in the up-and-down direction and the right-and -left direction can be reduced.

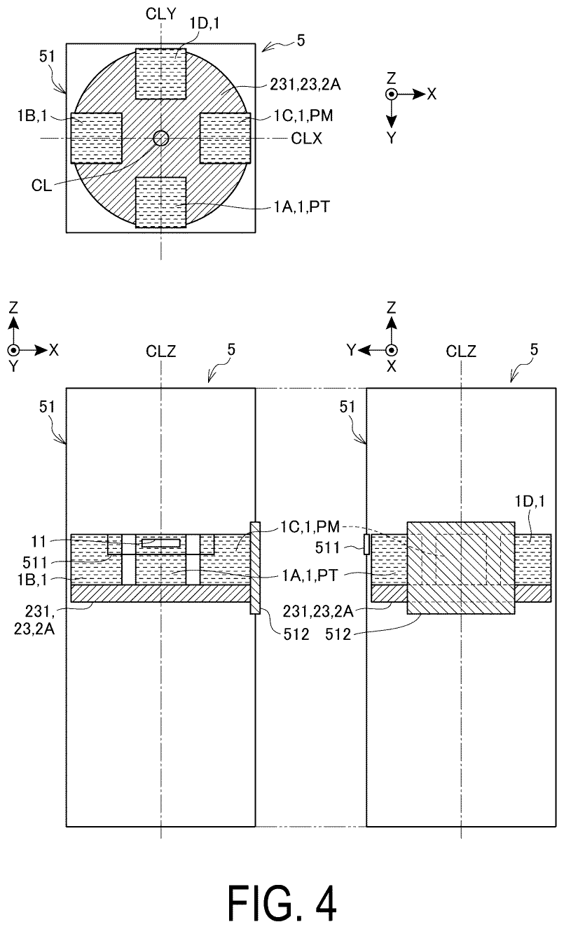

Next, with reference to FIG. 4, a configuration of a moving mechanism 2A according to a second embodiment is described. FIG. 4 is a view illustrating an example of the configuration of the moving mechanism 2A according to the second embodiment. The upper part of FIG. 4 is a plan view, the left part of FIG. 4 is a front view, and the right part of FIG. 4 is a side view.

As illustrated in FIG. 4, for example, the moving mechanism 2A is accommodated inside the housing 51 of the so-called self-checkout machine 5. The self-checkout machine 5 is a checkout machine (cash register machine) with which a customer executes a settlement operation. For example, the self-checkout machine 5 is installed at a supermarket or the like.

The housing 51 includes the take-out port 511 and the maintenance door 512.

The take-out port 511 is a receipt reception tray configured so that a user can take out a receipt discharged from the first printer 1A. The take-out position PT is set so that the discharge port 11 through which the receipt from the first printer 1A is discharged overlaps with at least a part of the take-out port 511 in front view of the take-out port 511. For example, the take-out position PT is a position of the first printer 1A at which the receipt from the first printer 1A can be taken out through the take-out port 511. Note that, in the moving mechanism 2A according to the second embodiment, the position of the first printer 1A is a position in the right-and-left direction and a position in the front-and-rear direction.

The first printer 1A corresponds to an example of a “first printing device”.

The maintenance door 512 is arranged at a position facing the maintenance position PM, and allows a user to execute maintenance work for the third printer 1C. The maintenance position PM is a position at which the maintenance work is executed. The third printer 1C is the printer 1 being a target subjected to the maintenance work.

As illustrated in FIG. 4, in the second embodiment, the maintenance door 512 is arranged at the right side surface of the housing 51. Further, for example, the maintenance door 512 turns rightward with the support shaft, which is arranged at the lower end of the maintenance door 512, as a center to be in an opened state. The maintenance door 512 is configured so that the roll paper P of the third printer 1C can be replaced while the maintenance door 512 is in an opened state.

The third printer 1C corresponds to an example of a “third printing device”.

The moving mechanism 2A moves the positions of the plurality of printers 1. The moving mechanism 2A rotates and moves the plurality of printers 1 with a center axis CL along the vertical direction as a center. In the moving mechanism 2A according to the second embodiment, the plurality of printers 1 includes the first printer 1A, the second printer 1B, the third printer 1C, and a fourth printer 1D.

The moving mechanism 2A includes a rotation mechanism 23. The rotation mechanism 23 includes a rotation member 231. The rotation member 231 is configured to freely rotate about the center axis CL as a center. The center axis CL is substantially parallel to the vertical direction. The rotation member 231 is formed to have a substantially disk-like shape. The rotation member 231 is arranged so that the upper surface of the rotation member 231 is horizontal. The rotation member 231 is configured to freely rotate while being supported by a support member of the rotation mechanism 23, which is omitted in illustration. The rotation member 231 is driven to rotate about the center axis CL as a center, by a motor of the rotation mechanism 23, which is omitted in illustration. The motor drives the rotation member 231 to rotate about the center axis CL as a center, according to an instruction from the control device 3.

Further, a sensor, which is omitted in illustration is arranged at the rotation mechanism 23. The sensor detects a rotation position of the rotation member 231. Based on the detection result of the sensor, the control device 3 drives the motor.

The configuration of the control device 3 is further described with reference to FIG. 5.

The first printer 1A, the second printer 1B, the third printer 1C, and the fourth printer 1D are placed on the upper surface of the rotation member 231.

As illustrated in the plan view of FIG. 4, the first printer 1A and the fourth printer 1D are arranged so that the center position of each of the first printer 1A and the fourth printer 1D in the right-and-left direction matches with a center axis CLY of the rotation member 231 in the right-and-left direction. The center axis CLY is a linear line that is parallel to the Y-axis and passes through the center axis CL. The first printer 1A is arranged at the front terminal of the rotation member 231, and the fourth printer 1D is arranged at the rear end of the rotation member 231.

Further, the second printer 1B and the third printer 1C are arranged so that the center position of each of the second printer 1B and the third printer 1C in the front-and-rear direction matches with a center axis CLX of the rotation member 231 in the front-and-rear direction. The center axis CLX is a linear line that is parallel to the X-axis and passes through the center axis CL. The second printer 1B is arranged at the left end of the rotation member 231, and the third printer 1C is arranged at the right end of the rotation member 231.

As illustrated in FIG. 4, in the first embodiment, a case in which the printer 1 is placed on the upper surface of the rotation member 231 is described. However, the embodiment is not limited thereto. The printer 1 may be fixed to the upper surface of the rotation member 231 by a bolt or the like. In this case, for example, even when an acceleration degree caused by driving the lift member 221 by the rotation mechanism 23 is relatively high, the position of the printer 1 with respect to the rotation mechanism 23 can be prevented from moving.

In the moving mechanism 2A according to the second embodiment illustrated in FIG. 4, the first printer 1A is arranged at the take-out position PT. The take-out position PT is a position of the printer 1 at which the receipt discharged from the printer 1 can be taken out through the take-out port 511. For example, the position of the printer 1 is the center position of the printer 1 in the right-and-left direction and the front-and-rear direction.

For example, the take-out position PT is set so that the discharge port 11 through which the receipt from the first printer is discharged overlaps with the take-out port 511 in front view of the take-out port 511. For example, the take-out position PT is set so that the discharge port 11 is included in the take-out port 511 in front view of the take-out port 511. In this case, the receipt discharged through the discharge port 11 can securely be placed on the take-out port 511.

In the moving mechanism 2A according to the second embodiment illustrated in FIG. 3, the third printer 1C is arranged at the maintenance position PM. The maintenance position PM is the position of the printer 1 when the maintenance work on the printer 1 is executed. In other words, the maintenance position PM is a position facing the maintenance door 512. For example, the position of the printer 1 is the center position of the printer 1 in the front-and-rear direction and the right-and-left direction. For example, the maintenance work includes work for replacing the roll paper P. When the maintenance door 512 is in an opened state, the maintenance work can easily be executed.

In the second embodiment, description is made on a case in which the moving mechanism 2A includes the rotation member 231 that rotates about the center axis CL as a center, the center axis CL being substantially parallel to the vertical direction. However, the embodiment is not limited thereto. For example, in place of the rotation member 231, the moving mechanism 2A may include a rotation member that rotates about a center axis, which is substantially parallel to the horizontal direction, as a center. For example, the moving mechanism 2A may include a rotation member that rotates about a center axis, which is substantially parallel to the front-and-rear direction, as a center. The rotation member rotates and moves the plurality of printers 1 with a center axis, which is substantially parallel to the front-and-rear direction, as a center. For example, the plurality of printers 1 includes the first printer 1A, the second printer 1B, the third printer 1C, and the fourth printer 1D.

In the second embodiment, the first printer 1A, the second printer 1B, the third printer 1C, and the fourth printer 1D are placed on the rotation member 231. However, when the plurality of printers 1 rotate and move with a center axis, which is substantially parallel to the front-and-rear direction, as a center, it is required to fix each of the plurality of printers 1 to the rotation member with a bolt or the like.

Further, instead of fixing each of the plurality of printers 1 to the rotation member with a bolt or the like, a support member may be provided to support the plurality of printers 1 so that the upper surfaces of the plurality of printers 1 are always oriented upward regardless of the rotation position of the rotation member.

For example, when the moving mechanism 2A includes a rotation mechanism that rotates and moves the plurality of printers 1 with a center axis, which is substantially parallel to the front-and-rear direction, as a center, the size of the moving mechanism 2A in the front-and-rear direction can be reduced.

Further, for example, when the moving mechanism 2A includes a rotation mechanism that rotates and moves the plurality of printers 1 with a center axis, which is substantially parallel to the right-and-left direction, as a center, the size of the moving mechanism 2A in the right-and-left direction can be reduced.

Next, with reference to FIG. 5, a configuration of a moving system 300 according to the present embodiment is described. FIG. 5 is a view illustrating an example of the configuration of the moving system according to the present embodiment.

As illustrated in FIG. 5, the moving system 300 includes the plurality of printers 1 and a moving device 400. The moving device 400 includes the moving mechanism 2 or the moving mechanism 2A, the control device 3, a notification mechanism 4, the take-out port 511 illustrated in FIG. 3 and FIG. 4, and the maintenance door 512 illustrated in FIG. 3 and FIG. 4.

For example, the plurality of printers 1 includes the first printer 1A, the second printer 1B, and the third printer 1C.

The moving mechanism 2 is the moving mechanism 2 described with reference to FIG. 3. The moving mechanism 2A is the moving mechanism 2A described with reference to FIG. 4.

For example, the notification mechanism 4 is an display lamp including a light emitting diode (LED) that emits light of a plurality of colors. The notification mechanism 4 causes the LED to emit light, according to an instruction from the control device 3.

Note that, for the sake of convenience, description is mainly made on a case in which the moving device 400 includes the moving mechanism 2. When the moving device 400 includes the moving mechanism 2A, the moving mechanism 2 may be replaced with the moving mechanism 2A. When the moving mechanism 2 cannot be replaced with the moving mechanism 2A, such a case is described.

The control device 3 is communicably coupled to the plurality of printers 1, the moving mechanism 2, and the notification mechanism 4. The control device 3 controls the plurality of printers 1, the moving mechanism 2, and the notification mechanism 4. The control device 3 includes a first control unit 31, an operation mechanism 32, a display mechanism 33, and a first communication interface 34. For example, the control device 3 is configured by a personal computer in which an application for controlling the plurality of printers 1, the moving mechanism 2, and the notification mechanism 4 is installed.

For example, the control device 3 is accommodated inside the housing 51 of the self-checkout machine 5.

The first control unit 31 includes a first processor 11A such as a central processing unit (CPU) and a first memory 31B such as a read-only memory (ROM). The first memory 31B stores a first control program PG1.

The first control unit 31 corresponds to an example of a “control unit”.

The first processor 11A may be configured by a plurality of processors, or may be a single processor.

The first processor 11A may be hardware that is programmed to execute a function of each unit described later. In other words, the first processor 11A may be configured by installing the first control program PG1 as a hardware circuit. In this case, for example, the first processor 11A is configured by an application specific integrated circuit (ASIC), a field programmable gate array (FPGA), or the like.

In the following description, description is made on a case in which various functions of the first control unit 31 are achieved by executing the first control program PG1 by the first processor 11A.

The first memory 31B includes a storage region in which a program executed by the first processor 11A and data processed by the first processor 11A are stored. The first memory 31B stores the first control program PG1 executed by the first processor 11A, and various types of image data, setting data, and the like that relate to an operation of the control device 3.

The first memory 31B includes a non-volatile storage region that stores a program and data in a non-volatile manner. For example, as the non-volatile storage region, the first memory 31B may include a ROM, a hard disk drive (HDD), a solid state drive (SSD), and or the like. Further, the first memory 31B may include a volatile storage region that configures a work area for temporarily storing a program executed by the first processor 11A and processing target data. For example, as the volatile storage region, the first memory 31B may include a random access memory (RAM) or the like.

For example, the operation mechanism 32 is communicably coupled to a keyboard, a mouse, or the like, receives an operation from a user, and outputs an operation signal corresponding to the received operation to the first control unit 31. The display mechanism 33 displays various types of information on a display such as a liquid crystal display (LCD), according to control of the first control unit 31.

For example, the first communication interface 34 is a communication interface that executes communication with the printer 1 according to Ethernet (registered trademark) standards. The first communication interface 34 includes a transmission/reception circuit that transmits and receives an Ethernet (registered trademark) signal and an interface circuit that processes a signal transferred through the transmission/reception circuit. The first communication interface 34 is an interface substrate including a transmission/reception circuit and an interface circuit, and is coupled to a main substrate on which a first processor 31A of the first control unit 31 and the like are mounted. Alternatively, the transmission/reception circuit and the interface circuit that configure the first communication interface 34 are mounted on the main substrate of the first control unit 31. The first communication interface 34 receives state information indicating a state of the printer 1 from the printer 1, and transmits printing instruction information to the printer 1.

The printer 1 includes a second control unit 100, a printing mechanism 103, and a second communication interface 104.

The second control unit 100 includes a second processor 101 such as a CPU and a second memory 102 such as a ROM. The second memory 102 stores a second control program PG2.

The second processor 101 may be configured by a plurality of processors, or may be a single processor.

The second processor 101 may be hardware that is programmed to execute various functions. In other words, the second processor 101 may be configured by installing the second control program PG2 as a hardware circuit. In this case, for example, the second processor 101 is configured by an ASIC, an FPGA, or the like.

The printing mechanism 103 includes the printing head 113 illustrated in FIG. 2. The printing mechanism 103 transports the roll paper P, and forms various images on the roll paper P by the printing head 113. Then, the printing mechanism 103 causes the fixed blade 114b and the movable blade 114c to cut the roll paper P on which an image is formed, and discharges the receipt through the discharge port 11.

The second communication interface 104 is a communication interface that executes communication with the control device 3 according to Ethernet (registered trademark) standards. The second communication interface 104 includes a transmission/reception circuit that transmits and receives an Ethernet (registered trademark) signal and an interface circuit that processes a signal transferred through the transmission/reception circuit. The second communication interface 104 is an interface substrate including a transmission/reception circuit and an interface circuit, and is coupled to a main substrate on which the second processor 101 of the second control unit 100 and the like are mounted. Alternatively, the transmission/reception circuit and the interface circuit that configure the second communication interface 104 are mounted on the main substrate of the second control unit 100. The second communication interface 104 transmits state information indicating a state of the printer 1 to the control device 3, and receives printing instruction information from the control device 3.

The first processor 31A reads out and executes the first control program PG1 stored in the first memory 31B. With this, the first control unit 31 controls each of the units of the printer 1. The first processor 31A executes the first control program PG1 stored in the first memory 31B to function as a monitoring unit 311, a movement instruction unit 312, a selection unit 313, a reception unit 314, a notification unit 315, and a cancellation unit 316.

The first control program PG1 corresponds to an example of a “movement control program”.

The monitoring unit 311 monitors a state of each of the plurality of printers 1. The monitoring unit 311 acquires state information JP indicating a state of the printer 1 from each of the plurality of printers 1. The state of the printer 1 includes the following five states.

A first state C1: a state in which the printing processing can be executed.

A second state C2: a state in which a remaining amount of the roll paper P is insufficient.

A third state C3: a state in which a transport failure occurs.

A fourth state C4: a state in which a malfunction occurs.

A fifth state C5: a state in which replacement is required.

The first state C1 is a state in which the printer 1 is normal. The second state C2, the third state C3, and the fourth state C4 are states in which maintenance is required. The fifth state C5 is a state in which replacement of the printer 1 is required.

When the reception unit 314 receives repair-unavailable information, the monitoring unit 311 changes the state information JP relating to the third printer 1C, to the fifth state C5. The repair-unavailable information indicates that maintenance cannot bring the printer 1 to a state in which the printing processing can be executed.

The movement instruction unit 312 causes the moving mechanism 2 to move the position of the first printer 1A to the take-out position PT at which the receipt can be taken out through the take-out port 511, based on a monitoring result of the monitoring unit 311. The first printer 1A is the printer 1 selected by the selection unit 313.

When printing is interrupted due to a shortage of the roll paper P in the first printer 1A, the movement instruction unit 312 causes the moving mechanism 2 to move the position of the second printer 1B to the take-out position PT. Note that the second printer 1B is the printer 1 selected by the selection unit 313.

Further, when transport of the roll paper P is stopped due to occurrence of a transport failure in the first printer 1A, the movement instruction unit 312 causes the moving mechanism 2 to move the position of the second printer 1B to the take-out position PT.

Further, when transport of the roll paper P is stopped due to occurrence of a malfunction in the first printer 1A, the movement instruction unit 312 causes the moving mechanism 2 to move the position of the second printer 1B to the take-out position PT.

The second printer 1B corresponds to an example of a “second printing device”.

When the reception unit 314 receives a maintenance instruction for executing the maintenance work for the third printer 1C different from the first printer 1A among the plurality of printers 1, the movement instruction unit 312 causes the moving mechanism 2 to move the third printer 1C to the maintenance position PM. The maintenance position PM is a position at which the maintenance work is executed.

The third printer 1C is the printer 1 whose state information JP indicates the second state C2, the third state C3, or the fourth state C4.

The selection unit 313 selects, from the plurality of printers 1, the first printer 1A as the printer 1 capable of executing the printing processing, based on a monitoring result of the monitoring unit 311. The printing processing is processing for printing an image on the roll paper P. In other words, the first printer 1A is the printer 1 whose state information JP indicates the first state C1.

When printing by the first printer 1A is interrupted, or transport of the roll paper P in the first printer 1A is stopped, the selection unit 313 selects the second printer 1B. The second printer 1B is the printer 1 different from the first printer 1A among the plurality of printers 1, and is the printer 1 capable of executing the printing processing. In other words, the second printer 1B is the printer 1 whose state information JP indicates the first state C1, and is different from the first printer 1A.

The reception unit 314 receives a maintenance instruction for executing the maintenance work for the third printer 1C different from the first printer 1A among the plurality of printers 1.

For example, when a user presses down a maintenance button, which is omitted in illustration, the reception unit 314 receives a maintenance instruction. For example, a user is an administrator of the self-checkout machine 5 or a service person who performs maintenance on the printer 1.

Further, the reception unit 314 receives the repair-unavailable information indicating that maintenance cannot bring the third printer 1C to a state in which the printing processing can be executed.

For example when a user presses down a repair-unavailable button, which is omitted in illustration, the reception unit 314 receives the repair-unavailable information. For example, a user is an administrator of the self-checkout machine 5 or a service person who performs maintenance on the printer 1.

In a case in which the reception unit 314 receives a maintenance instruction, when the third printer 1C is not at the maintenance position PM, the notification unit 315 causes the notification mechanism 4 to output an alert. For example, the notification unit 315 lights up the LED of the notification mechanism 4 in a red color.

In a case in which the reception unit 314 receives a maintenance instruction, when the third printer 1C is not at the maintenance position PM, the movement instruction unit 312 causes the moving mechanism 2 to move the position of the third printer 1C to the maintenance position PM. In other words, the moving mechanism 2 executes an operation of moving the plurality of printers 1. Thus, in order to secure safety, the notification mechanism 4 is caused to output an alert.

When the reception unit 314 receives the repair-unavailable information, the cancellation unit 316 cancels a maintenance instruction for the third printer 1C. In other words, when the reception unit 314 receives the repair-unavailable information, the cancellation unit 316 cancels a maintenance instruction for the third printer 1C. Further, the monitoring unit 311 changes the state information JP relating to the third printer 1C, to the fifth state C5.

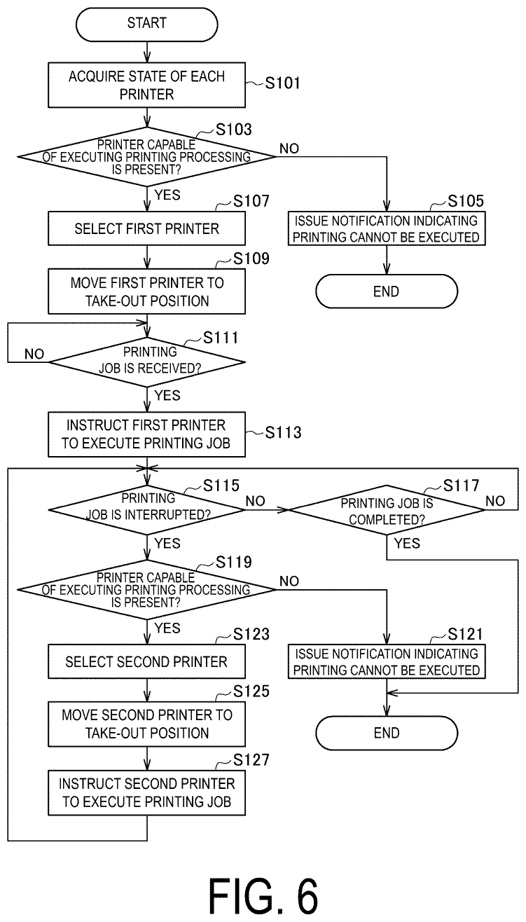

Next, with reference to FIG. 6, processing of the first control unit 31 of the control device 3 is described. FIG. 6 is a flowchart illustrating an example of processing of the first control unit 31.

As illustrated in FIG. 6, first, in Step S101, the monitoring unit 311 acquires the state information JP indicating the state of the printer 1 from each of the plurality of printers 1.

Subsequently, in Step S103, the selection unit 313 determines whether the printer 1 capable of executing the printing processing is present among the plurality of printers 1.

When the selection unit 313 determines that the printer 1 capable of executing the printing processing is not present (Step S103; NO), the processing proceeds to Step S105.

Further, in Step S105, the notification unit 315 causes the notification mechanism 4 to issue an output indicating that printing cannot be executed. For example, the notification unit 315 causes the LED of the notification mechanism 4 to flash in a red color. Then, the processing is terminated.

When the selection unit 313 determines that the printer 1 capable of executing the printing processing is present (Step S103; YES), the processing proceeds to Step S107.

Further, in Step S107, the selection unit 313 selects the first printer 1A as the printer 1 capable of executing the printing processing.

Subsequently, in Step S109, the movement instruction unit 312 causes the moving mechanism 2 to move the position of the first printer 1A to the take-out position PT. The take-out position PT indicates the position of the printer 1 at which the receipt can be taken out through the take-out port 511.

Subsequently, in Step S111, the first control unit 31 determines whether a printing job is received. For example, the printing job is instructed from a point-of-sale (POS) terminal device, which is arranged in the self-checkout machine 5 and is omitted in illustration, to the first control unit 31.

When the first control unit 31 determines that the printing job is not received (Step S111; NO), the processing is in a standby state. When the first control unit 31 determines that the printing job is received (Step S111; YES), the processing proceeds to Step S113.

Further, in Step S113, the first control unit 31 instructs the first printer 1A to execute the printing job.

Subsequently, in Step S115, the monitoring unit 311 determines whether execution of the printing job is interrupted in the first printer 1A. For example, when the monitoring unit 311 acquires, from the first printer 1A, the state information JP indicating the second state C2, the third state C3, or the fourth state C4, the monitoring unit 311 determines that execution of the printing job is interrupted in the first printer 1A.

When the monitoring unit 311 determines that execution of the printing job is interrupted in the first printer 1A (Step S115; YES), the processing proceeds to Step S119. When the monitoring unit 311 determines that execution of the printing job is not interrupted in the first printer 1A (Step S115; NO), the processing proceeds to Step S117.

Further, in Step S117, the first control unit 31 determines whether the printing job is completed in the first printer 1A. When the printing job is completed, the receipt is discharged from the discharge port 11 to the take-out port 511.

After when the first control unit 31 determines that the printing job is completed (Step S117; YES), the processing is terminated. When the first control unit 31 determines that the printing job is not completed (Step S117; NO), the processing returns to Step S115.

In a case of YES in Step S115, in Step S119, the selection unit 313 determines whether the printer 1 capable of executing the printing processing is present among the plurality of printers 1. When the selection unit 313 determines that the printer 1 capable of executing the printing processing is not present (Step S119; NO), the processing proceeds to Step S121.

Further, in Step S121, the notification unit 315 causes the notification mechanism 4 to issue an output indicating that printing cannot be executed. For example, the notification unit 315 causes the LED of the notification mechanism 4 to flash in a red color. Then, the processing is terminated.

When the selection unit 313 determines that the printer 1 capable of executing the printing processing is present (Step S119; YES), the processing proceeds to Step S123.

Further, in Step S123, the selection unit 313 selects the second printer 1B. The second printer 1B is the printer 1 different from the first printer 1A among the plurality of printers 1, and is the printer 1 capable of executing the printing processing.

Subsequently, in Step S125, the movement instruction unit 312 causes the moving mechanism 2 to move the position of the second printer 1B to the take-out position PT. The take-out position PT indicates the position of the printer 1 at which the receipt can be taken out through the take-out port 511.

Subsequently, in Step S127, the first control unit 31 instructs the second printer 1B to execute the printing job. After that, the processing returns to Step S115, and the processing after Step S115 is repeatedly executed. Note that, in the processing after Step S115, the processing is executed for the second printer 1B in place of the first printer 1A.

Step S101 corresponds to an example of a “monitoring step”.

Step S109 corresponds to an example of a “movement instruction step”.

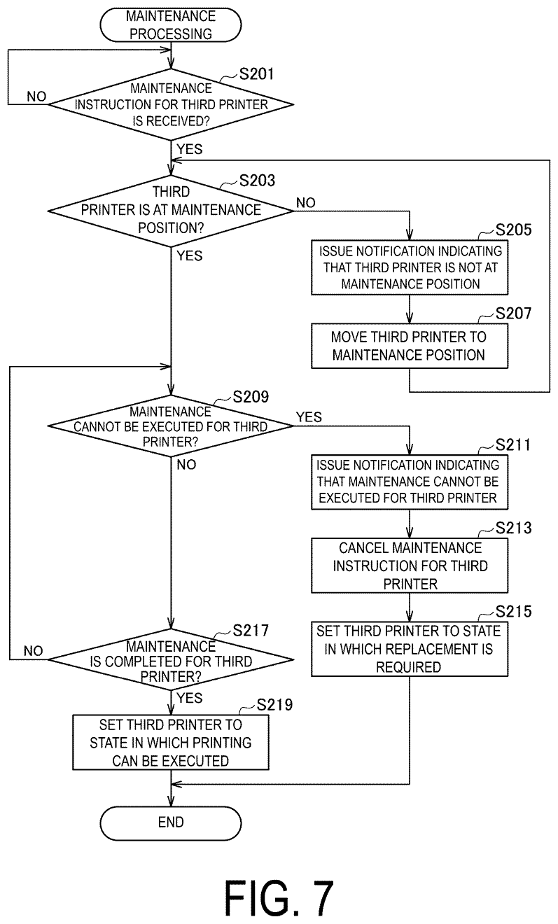

Next, with reference to FIG. 7, an example of maintenance processing of the first control unit 31 is described. The “maintenance processing” is processing for moving the printer 1 that requires maintenance, for example, the third printer 1C to the maintenance position PM and executing maintenance on the third printer 1C by a service person.

FIG. 7 is a flowchart illustrating an example of the maintenance processing of the first control unit 31.

First, in Step S201, the reception unit 314 determines whether a maintenance instruction for executing the maintenance work for the third printer 1C is received. For example, when a user presses down a maintenance button, which is omitted in illustration, the reception unit 314 receives a maintenance instruction.

When the reception unit 314 determines that a maintenance instruction is not received, (Step S201; NO), the processing is in a stand-by state. When the reception unit 314 determines that a maintenance instruction is received (Step S201; YES), the processing proceeds to Step S203.

Further, in Step S203, the movement instruction unit 312 determines whether the third printer 1C is at the maintenance position PM.

When the movement instruction unit 312 determines that the third printer 1C is at the maintenance position PM (Step S203; YES), the processing proceeds to Step S209. When the movement instruction unit 312 determines that the third printer 1C is not at the maintenance position PM (Step S203; NO), the processing proceeds to Step S205.

Further, in Step S205, the notification unit 315 causes the notification mechanism 4 to issue an input indicating that the third printer 1C is not at the maintenance position PM. For example, the notification unit 315 lights up the LED of the notification mechanism 4 in a red color.

Subsequently, in Step S207, the movement instruction unit 312 moves the third printer 1C to the maintenance position PM. After that, the processing returns to Step S203.

In a case of YES in Step S203, in Step S209, the reception unit 314 determines whether the repair-unavailable information indicating that maintenance cannot bring the third printer 1C to a state in which the printing processing can be executed is received.

When the reception unit 314 determines that the repair-unavailable information is not received (Step S209; NO), the processing proceeds to Step S217. When the reception unit 314 determines that the repair-unavailable information is received (Step S209; YES), the processing proceeds to Step S211.

Further, in Step S211, the notification unit 315 causes the notification mechanism 4 to issue an output indicating that maintenance cannot achieve a state in which the printing processing can be executed. For example, the notification unit 315 lights up the LED of the notification mechanism 4 in a yellow color.

Further, in Step S213, the cancellation unit 316 cancels a maintenance instruction for the third printer 1C.

Subsequently, in Step S215, the monitoring unit 311 changes the state of the third printer 1C to the fifth state C5. The fifth state C5 indicates a state in which replacement is required. After that, the maintenance processing is terminated.

In a case of NO in Step S209, in Step S217, the monitoring unit 311 determines whether maintenance on the third printer 1C is completed.

When the monitoring unit 311 determines that maintenance on the third printer 1C is completed (Step S217; NO), the processing returns to Step S209. When the monitoring unit 311 determines that maintenance on the third printer 1C is completed (Step S217; YES), the processing proceeds to Step S219.

Further, in Step S219, the monitoring unit 311 changes the state of the third printer 1C to the first state C1. The first state C1 indicates a state in which the printing processing can be executed. After that, the maintenance processing is terminated.

As described above with reference to FIG. 1 to FIG. 7, the moving device 400 according to the present embodiment includes the moving mechanism 2, 2A configured to support the plurality of printers 1 and move the positions of the plurality of printers 1, the plurality of printers 1 being configured to execute the printing processing for executing printing on the roll paper P, the take-out port 511 through which a user takes out the receipt discharged from the first printer 1A being one printer 1 of the plurality of printers 1, and the first control unit 31 configured to communicate with the plurality of printers 1 and control the moving mechanism 2, 2A, wherein the first control unit 31 includes the monitoring unit 311 configured to monitor a state of each of the plurality of printers 1, and the movement instruction unit 312 configured to cause the moving mechanism 2, 2A to move the position of the first printer 1A to the take-out position PT at which the receipt can be taken out through the take-out port 511, based on a monitoring result of the monitoring unit 311.

With this, a state of each of the plurality of printers 1 is monitored, and the moving mechanism 2, 2A is caused to move the position of the first printer 1A to the take-out position PT at which the receipt can be taken out through the take-out port 511, based on a monitoring result. Thus, for example, when a malfunction occurs in the printer 1 arranged at the take-out position PT, the position of the first printer 1A, which is the printer 1 capable of executing the printing processing, moves to the take-out position PT. As a result, the time during which the printing is interrupted can be shortened. Therefore, convenience for a user can be improved.

Further, in the moving device 400, the first control unit 31 includes the selection unit 313 that selects, from the plurality of printers 1, the first printer 1A as the printer 1 capable of executing the printing processing, based on a monitoring result of the monitoring unit 311.

With this, the first printer 1A is selected from the plurality of printers 1, as the printer 1 capable of executing the printing processing, based on a monitoring result of the monitoring unit 311. Thus, the first printer 1A can be selected from the plurality of printers 1, as the printer 1 capable of executing the printing processing. Therefore, the printer 1 suitable as the first printer 1A can be selected.

Further, according to the moving device 400, in the first control unit 31, when printing is interrupted due to a shortage of the roll paper P in the first printer 1A, the selection unit 313 selects the second printer 1B, which is the printer 1 different from the first printer 1A among the plurality of printers 1 and is the printer 1 capable of executing the printing processing, and the movement instruction unit 312 causes the moving mechanism 2, 2A to move the position of the second printer 1B to the take-out position PT.

With this, when printing is interrupted due to a shortage of the roll paper P in the first printer 1A, the second printer 1B, which is the printer 1 different from the first printer 1A among the plurality of printers 1 and is the printer 1 capable of executing the printing processing, is selected, and the moving mechanism 2, 2A is caused to move the position of the second printer 1B to the take-out position PT.

Thus, when printing is interrupted due to a shortage of the roll paper P in the first printer 1A, the position of the second printer 1B, which is the printer 1 capable of executing the printing processing, moves to the take-out position PT. As a result, the time during which the printing is interrupted can be shortened. Therefore, convenience for a user can be improved.

Further, according to the moving device 400, in the first control unit 31, when transport of the roll paper P is stopped due to occurrence of a transport failure in the first printer 1A, the selection unit 313 selects the second printer 1B, which is the printer 1 different from the first printer 1A among the plurality of printers 1 and is the printer 1 capable of executing the printing processing, and the movement instruction unit 312 causes the moving mechanism 2, 2A to move the position of the second printer 1B to the take-out position PT.

With this, when transport of the roll paper P is stopped due to occurrence of a transport failure in the first printer 1A, the second printer 1B, which is the printer 1 different from the first printer 1A among the plurality of printers 1 and is the printer 1 capable of executing the printing processing, is selected, and the moving mechanism 2, 2A is caused to move the position of the second printer 1B to the take-out position PT.

Thus, when transport of the roll paper P is stopped due to occurrence of a transport failure in the first printer 1A, the position of the second printer 1B, which is the printer 1 capable of executing the printing processing, moves to the take-out position PT. As a result, the time during which the printing is interrupted can be shortened. Therefore, convenience for a user can be improved.

Further, according to the moving device 400, in the first control unit 31, when transport of the roll paper P is stopped due to occurrence of a malfunction in the first printer 1A, the selection unit 313 selects the second printer 1B, which is the printer 1 different from the first printer 1A among the plurality of printers 1 and is the printer 1 capable of executing the printing processing, and the movement instruction unit 312 causes the moving mechanism 2, 2A to move the position of the second printer 1B to the take-out position PT.

With this, when transport of the roll paper P is stopped due to occurrence of a malfunction in the first printer 1A, the second printer 1B, which is the printer 1 different from the first printer 1A among the plurality of printers 1 and is the printer 1 capable of executing the printing processing, is selected, and the moving mechanism 2, 2A is caused to move the position of the second printer 1B to the take-out position PT. Thus, when transport of the roll paper P is stopped due to occurrence of a malfunction in the first printer 1A, the position of the second printer 1B, which is the printer 1 capable of executing the printing processing, moves to the take-out position PT. As a result, the time during which the printing is interrupted can be shortened. Therefore, convenience for a user can be improved.

Further, in the moving device 400, the first control unit 31 includes the reception unit 314 that receives a maintenance instruction for executing the maintenance work for the third printer 1C different from the first printer 1A among the plurality of printers 1. When the reception unit 314 receives a maintenance instruction, the movement instruction unit 312 causes the moving mechanism 2, 2A to move the third printer 1C to the maintenance position PM, which is a position at which the maintenance work is executed.

With this, when a maintenance instruction for executing the maintenance work for the third printer 1C different from the first printer 1A among the plurality of printers 1 is received, the moving mechanism 2, 2A is caused to move the third printer 1C to the maintenance position PM, which is a position at which the maintenance work is executed.

Thus, for example, when the maintenance position PM is a position different from the take-out position PT, the printing processing by the first printer 1A and the maintenance work on the third printer 1C can be executed simultaneously. Therefore, the time during which the printing processing by the first printer 1A is interrupted, which is caused by executing the maintenance work on the third printer 1C, can be shortened.

Further, in the moving device 400, the moving mechanism 2 includes the lift mechanism 22 that moves the plurality of printers 1 in the vertical direction with respect to the take-out port 511, and the plurality of printers 1 are arranged at an equal interval in the lift mechanism 22. The equal interval in the present application may include an interval considering design margins and manufacturing variations. In other words, the interval may be equal or substantially equal.

With this, the moving mechanism 2 includes the lift mechanism 22 that moves the plurality of printers 1 in the vertical direction with respect to the take-out port 511, and the plurality of printers 1 are arranged at an equal interval in the lift mechanism 22. As a result, the size of the moving mechanism 2 in the front-and-rear direction and the right-and-left direction can be reduced. Thus, for example, the size of the housing 51 of the self-checkout machine 5 in which the moving mechanism 2 is accommodated can be reduced in the front-and-rear direction and the right-and-left direction. Therefore, a space required for arranging the self-checkout machine 5 can be reduced.

Further, in the moving device 400, the moving mechanism 2 includes the slide mechanism that moves the plurality of printers 1 in the horizontal direction with respect to the take-out port 511, and the plurality of printers 1 are arranged at an equal interval in the slide mechanism.

With this, the moving mechanism 2 includes the slide mechanism that moves the plurality of printers 1 in the horizontal direction, for example, the right-and-left direction with respect to the take-out port 511, and the plurality of printers 1 are arranged at an equal interval in the slide mechanism. As a result, the size of the moving mechanism 2 in the up-and-down direction and the front-and-rear direction can be reduced. Thus, for example, the size of the housing 51 of the self-checkout machine 5 in which the moving mechanism 2 is accommodated can be reduced in the up-and-down direction and the front-and-rear direction. Therefore, a space required for arranging the self-checkout machine 5 can be reduced.

Further, in the moving device 400, the moving mechanism 2A includes the rotation mechanism 23 that rotates and moves the plurality of printers 1 with a center axis along the vertical direction as a center, and the plurality of printers 1 are arranged at an equal interval in the rotation mechanism 23.

With this, the moving mechanism 2A includes the rotation mechanism 23 that rotates and moves the plurality of printers 1 with a center axis along the vertical direction as a center, and the plurality of printers 1 are arranged at an equal interval in the rotation mechanism 23. As a result, the size of the moving mechanism 2 in the up-and-down direction can be reduced. Thus, for example, the size of the housing 51 of the self-checkout machine 5 in which the moving mechanism 2 is accommodated can be reduced in the up-and-down direction. Therefore, a space required for arranging the self-checkout machine 5 can be reduced.

Further, in the moving device 400, the moving mechanism 2A includes the rotation mechanism that rotates and moves the plurality of printers 1 with a center axis along the horizontal direction as a center, and the plurality of printers 1 are arranged at an equal interval in the rotation mechanism.

With this, the moving mechanism 2A includes the rotation mechanism that rotates and moves the plurality of printers 1 with a center axis along the horizontal direction, for example, the front-and-rear direction as a center, and the plurality of printers 1 are arranged at an equal interval in the rotation mechanism. As a result, the size of the moving mechanism 2 in the front-and-rear direction can be reduced. Thus, for example, the size of the housing 51 of the self-checkout machine 5 in which the moving mechanism 2 is accommodated can be reduced in the front-and-rear direction. Therefore, a space required for arranging the self-checkout machine 5 can be reduced.

Further, the moving device 400 includes the maintenance door 512 through which a user can execute the maintenance work for the third printer 1C, the maintenance door 512 being arranged at a position facing the maintenance position PM. The maintenance door 512 is configured so that replacement work of the roll paper P is executed by opening the maintenance door 512.

With this, the maintenance door 512 is arranged at a position facing the maintenance position PM, and is configured so that replacement work of the roll paper P is executed by opening the maintenance door 512. Thus, the third printer 1C is arranged at the maintenance position PM. As a result, a user can easily execute the maintenance work for the third printer 1C. Therefore, convenience for a user can be improved.

Further, in the moving device 400, when the first printer 1A is at the take-out position PT, the maintenance door 512 is arranged at a position at which a user can execute the maintenance work for the third printer 1C.

With this, when the first printer 1A is at the take-out position PT, the maintenance door 512 is arranged at a position at which a user can execute the maintenance work for the third printer 1C. Thus, the printing processing by the first printer 1A and the maintenance work on the third printer 1C can be executed simultaneously. Therefore, the time during which the printing processing by the first printer 1A is interrupted, which is caused by executing the maintenance work on the third printer 1C, can be shortened.

Further, in the moving device 400, the take-out position PT is set so that the discharge port 11 through which the receipt from the first printer 1A is discharged overlaps with at least a part of the take-out port 511 in front view of the take-out port 511.

With this, the take-out position PT is set so that the discharge port 11 through which the receipt from the first printer 1A is discharged overlaps with at least a part of the take-out port 511 in front view of the take-out port 511. Thus, the receipt discharged through the discharge port 11 of the first printer 1A can be placed on the take-out port 511. Therefore, for example, a user can receive the receipt through the take-out port 511 formed in the housing 51 of the self-checkout machine 5.

Further, the moving device 400 includes the notification mechanism 4 that outputs an alert to the outside. The first control unit 31 includes the notification unit 315. In a case in which the reception unit 314 receives a maintenance instruction, when the third printer 1C is not at the maintenance position PM, the notification unit 315 causes the notification mechanism 4 to output an alert.

With this, in a case in which a maintenance instruction, when the third printer 1C is not at the maintenance position PM, the notification mechanism 4 is caused to output an alert. Thus, a user can recognize that the third printer 1C is not at the maintenance position PM. Therefore, a user can prepare for an operation of moving the third printer 1C to the maintenance position PM. As a result, safety for a user can be secured.

Further, in the moving device 400, the reception unit 314 receives the repair-unavailable information indicating that maintenance cannot bring the third printer 1C to a state in which the printing processing can be executed. The first control unit 31 includes the cancellation unit 316 that cancels a maintenance instruction for the third printer 1C when the reception unit 314 receives the repair-unavailable information.

With this, when the repair-unavailable information indicating that maintenance cannot bring the third printer 1C to a state in which the printing processing can be executed is received, a maintenance instruction for the third printer 1C is canceled. Thus, when maintenance cannot bring the third printer 1C to a state in which the printing processing can be executed, execution of an operation corresponding to a maintenance instruction can be avoided. Further, it can be determined that replacement of the third printer 1C is required. Therefore, the first control unit 31 can notify a user that replacement of the third printer 1C is required.

Further, the moving system 300 according to the present embodiment includes the moving device 400 configured to support the plurality of printers 1 and move the positions of the plurality of printers 1, the plurality of printers 1 being configured to execute the printing processing for executing printing on the roll paper P, the take-out port 511 through which a user takes out the receipt discharged from the first printer 1A being one printer 1 of the plurality of printers 1, and the control device 3 configured to communicate with the plurality of printers 1 and control the moving mechanism 2, 2A, wherein the control device 3 includes the monitoring unit 311 configured to monitor a state of each of the plurality of printers 1, and the movement instruction unit 312 configured to cause the moving device 400 to move the position of the first printer 1A to the take-out position PT at which the receipt can be taken out through the take-out port 511, based on a monitoring result of the monitoring unit 311.

With this, the effects similar to the effects of the moving device 400 described above can be exerted.

Further, in the moving device 400 including the moving mechanism 2, 2A configured to support the plurality of printers 1 and move the positions of the plurality of printers 1, the plurality of printers 1 being configured to execute the printing processing for executing printing on the roll paper P, the take-out port 511 through which a user takes out the receipt discharged from the first printer 1A being one printer 1 of the plurality of printers 1, and the first control unit 31 configured to communicate with the plurality of printers 1 and control the moving mechanism 2, 2A, the moving method according to the present embodiment includes the monitoring step by the first control unit 31 for monitoring a state of each of the plurality of printers 1 and the movement instruction step by the first control unit 31 for causing the moving mechanism 2, 2A to move the position of the first printer 1A to the take-out position PT at which the receipt can be taken out through the take-out port 511, based on a monitoring result in the monitoring step.

With this, the effects similar to the effects of the moving device 400 described above can be exerted.

Further, in the moving device 400 including the moving mechanism 2, 2A configured to support the plurality of printers 1 and move the positions of the plurality of printers 1, the plurality of printers 1 being configured to execute the printing processing for executing printing on the roll paper P, the take-out port 511 through which a user takes out the receipt discharged from the first printer 1A being one printer 1 of the plurality of printers 1, and the first control unit 31 configured to communicate with the plurality of printers 1 and control the moving mechanism 2, 2A, the first control program PG1 according to the present embodiment causes the first processor 31A included in the first control unit 31 to function as the monitoring unit 311 and the movement instruction unit 312. The monitoring unit 311 monitors a state of each of the plurality of printers 1, and the movement instruction unit 312 causes the moving mechanism 2, 2A to move the position of the first printer 1A to the take-out position PT at which the receipt can be taken out through the take-out port 511, based on a monitoring result of the monitoring unit 311.

With this, the effects similar to the effects of the moving device 400 described above can be exerted.

The present embodiment described above is merely a specific example to which the present disclosure is applied. The present disclosure is not limited to the configuration of the present embodiment described above, and can be implemented in various aspects without departing from the gist of the disclosure.

In the present embodiment described above, description is made on a case in which the control device 3 is configured by a personal computer. However, the embodiment is not limited thereto. The control device 3 may be configured by, for example, a smartphone, or may be configured by, for example, a tablet device.

In the present embodiment described above, description is made on a case in which the moving mechanism 2 is accommodated inside the housing 51 of the self-checkout machine 5. However, the embodiment is not limited thereto. For example, the moving mechanism 2 may be accommodated in a housing of an unmanned settlement machine.

In the present embodiment described above, description is made on a case in which the control device 3 executes communication with the plurality of printers 1 according to Ethernet (registered trademark) standards. However, the embodiment is not limited thereto. The control device 3 may communicate with the plurality of printers 1 according to, for example Wi-Fi (registered trademark) standards, or the control device 3 may communicate with the plurality of printers 1 according to, for example, Bluetooth (registered trademark) standards.

In the present embodiment described above, a case in which the printer 1 discharges the receipt is described. However, the embodiment is not limited thereto. For example, the printer 1 may discharge a label.

In the present embodiment described above, description is made on a case in which the plurality of printers 1 includes the first printer 1A, the second printer 1B, and the third printer 1C. However, the embodiment is not limited thereto. The plurality of printers 1 may include two printers 1, or the plurality of printers 1 may include four or more printers 1.

In the present embodiment described above, description is made on a case in which the maintenance door 512 is arranged at a position facing the maintenance position PM. However, the embodiment is not limited thereto. For example, the maintenance door 512 may be arranged at position facing the take-out position PT. In this case, a user may execute the maintenance work during a time zone in which the self-checkout machine 5 is not used, for example, a time zone in which a supermarket provided with the self-checkout machine 5 is closed.

In the present embodiment described above, description is made on a case in which the notification mechanism 4 is a display lamp including an LED that emits light in a plurality of colors. However, the embodiment is not limited thereto. For example, the notification mechanism 4 may be a display such as an LCD. In this case, the notification mechanism 4 can issue a notification containing detailed information.

The first processor 31A of the control device 3 may be configured by a single processor, or may be configured by a plurality of processors. Further, the first processor 31A may be hardware that is programmed to achieve the corresponding function unit. In other words, for example, the first processor 31A may be configured by an ASI or an FPGA.

Each of the units of the control device 3 illustrated in FIG. 5 is merely an example, and the specific implementation thereof is not particularly limited thereof is not particularly limited. In other words, hardware that corresponds individually to each of the units is not necessarily implemented, and a configuration in which a single processor executes a program to realize the function of each of the units is of course adoptable. Further, in the present embodiment described above, some of the functions enabled by software may be hardware, or some of the functions enabled by hardware may be enabled by software. In addition, the specific detailed configurations of the other units of the control device 3 can also be changed in a freely selected manner.

The steps of the operation illustrated in FIG. 6 and FIG. 7 is divided according to main processing contents in order to facilitate understanding of the processing of the first control unit 31 of the control device 3, and are not limited by the way of division of the processing and the name thereof. The processing may be divided into more steps according to the processing contents. Further, one step may be divided so as to include more processing. Further, the order of the steps may be switched as appropriate without hindering the gist of the present disclosure.

What is claimed is:

1. A moving device comprising:
a moving mechanism configured to support a plurality of printing devices and move positions of the plurality of printing devices, the plurality of printing devices being configured to execute printing processing for executing printing on roll paper;
a take-out port through which a user takes out a printed material discharged from a first printing device being one printing device of the plurality of printing devices; and
a control unit configured to communicate with the plurality of printing devices and control the moving mechanism, wherein
the control unit includes:
a monitoring unit configured to monitor a state of each of the plurality of printing devices; and
a movement instruction unit configured to cause the moving mechanism to move a position of the first printing device to a take-out position at which the printed material is taken out through the take-out port, based on a monitoring result of the monitoring unit.

2. A moving device according to claim 1, wherein
the control unit includes:
a selection unit configured to select the first printing device as a printing device to execute the printing processing, among the plurality of printing devices, based on a monitoring result of the monitoring unit.

3. A moving device according to claim 2, wherein
when the control unit interrupts printing due to a shortage of roll paper accommodated in the first printing device,
the selection unit selects a second printing device being a printing device different from the first printing device among the plurality of printing devices and a printing device to execute the printing processing, and
the movement instruction unit causes the moving mechanism to move a position of the second printing device to the take-out position.

4. A moving device according to claim 2, wherein
when the control unit stops transport of the roll paper due to occurrence of a transport failure in the first printing device,
the selection unit selects a second printing device being a printing device different from the first printing device among the plurality of printing devices and a printing device to execute the printing processing, and
the movement instruction unit causes the moving mechanism to move a position of the second printing device to the take-out position.

5. A moving device according to claim 2, wherein
the control unit stops transport of the roll paper due to occurrence of a malfunction in the first printing device,
the selection unit selects a second printing device being a printing device different from the first printing device among the plurality of printing devices and a printing device to execute the printing processing, and
the movement instruction unit causes the moving mechanism to move a position of the second printing device to the take-out position.

6. A moving device according to claim 1, wherein
the control unit includes:
a reception unit configured to receive a maintenance instruction for executing maintenance work for a third printing device different from the first printing device among the plurality of printing devices, wherein
when the reception unit receives the maintenance instruction, the movement instruction unit causes the moving mechanism to move a position of the third printing device to a maintenance position being a position at which the maintenance work is executed.

7. A moving device according to claim 1, wherein
the moving mechanism includes:
a lift mechanism configured to move three or more printing devices in a vertical direction with respect to the take-out port, and
the plurality of printing devices are arranged at an equal interval in the lift mechanism.

8. A moving device according to claim 1, wherein
the moving mechanism includes:
a slide mechanism configured to move three or more printing devices in a horizontal direction with respect to the take-out port, and
the plurality of printing devices are arranged at an equal interval in the slide mechanism.

9. A moving device according to claim 1, wherein
the moving mechanism includes:
a rotation mechanism configured to rotate and move three or more printing devices with a center axis along a vertical direction as a center, and
the plurality of printing devices are arranged at an equal interval in the rotation mechanism.

10. A moving device according to claim 1, wherein
the moving mechanism includes:
a rotation mechanism configured to rotate and move three or more printing devices with a center axis along a horizontal direction as a center, and
the plurality of printing devices are arranged at an equal interval in the rotation mechanism.

11. A moving device according to claim 6 comprising:
a maintenance door through which a user executes maintenance work for the third printing device, the maintenance door being arranged at a position facing the maintenance position, wherein
the maintenance door is configured so that replacement work of the roll paper is executed by opening the maintenance door.

12. A moving device according to claim 11, wherein
when the first printing device is at the take-out position, the maintenance door is arranged at a position at which a user executes maintenance work for the third printing device.

13. A moving device according to claim 1, wherein
the take-out position is set so that a discharge port of the first printing device through which the printed material is discharged overlaps with at least a part of the take-out port in front view of the take-out port.

14. A moving device according to claim 6, comprising:
a notification mechanism configured to output an alert to an outside, wherein
the control unit includes:
a notification unit configured to cause the notification mechanism to output an alert when the reception unit receives the maintenance instruction and the third printing device is not at the maintenance position.

15. A moving device according to claim 6, wherein
the reception unit receives repair-unavailable information indicating that maintenance does not achieve a state where the third printing device executes printing processing,
the control unit includes:
a cancellation unit configured to cancel the maintenance instruction for the third printing device when the reception unit receives the repair-unavailable information.

16. A moving system comprising:
a moving device configured to support a plurality of printing devices and move positions of the plurality of printing devices, the plurality of printing devices being configured to execute printing processing for executing printing on roll paper;
a take-out port through which a user takes out a printed material discharged from a first printing device being one printing device of the plurality of printing devices; and
a control device configured to communicate with the plurality of printing devices and control the moving device, wherein
the control device includes:
a monitoring unit configured to monitor a state of each of the plurality of printing devices; and
a movement instruction unit configured to cause the moving device to move a position of the first printing device to a take-out position at which the printed material is taken out through the take-out port, based on a monitoring result of the monitoring unit.

17. A moving method in a moving device comprising:
a moving mechanism configured to support a plurality of printing devices and move positions of the plurality of printing devices, the plurality of printing devices being configured to execute printing processing for executing printing on roll paper;
a take-out port through which a user takes out a printed material discharged from a first printing device being one printing device of the plurality of printing devices; and
a control unit configured to communicate with the plurality of printing devices and control the moving mechanism, the moving method comprising:
a monitoring step by the control unit for monitoring a state of each of the plurality of printing devices; and
a movement instruction step by the control unit for causing the moving mechanism to move a position of the first printing device to a take-out position at which the printed material is taken out through the take-out port, based on a monitoring result in the monitoring step.
